(19) United States
(12) Patent Application Publication
(10) Pub. No.: US 2005/0196645 A1
(43) Pub. Date: Sep. 8, 2005

(54) Magnetic tape

(75) Inventors: Tsugihiro Doi, Osaka (JP); Shinji Sakata, Osaka (JP); Tetsutaro Inoue, Osaka (JP); Sadamu Kuse, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 11/052,952

(22) Filed: Feb. 9, 2005

(30) Foreign Application Priority Data
Feb. 10, 2004 (JP) P2004-033902

(51) Int. Cl. G11B 5/187

(52) U.S. Cl. 428/845

(57) ABSTRACT

A magnetic tape having excellent high recording density characteristics, good durability and good servo-tracking characteristics, which comprises a non-magnetic support, a magnetic layer formed on one surface of the non-magnetic support and containing a magnetic powder, a primer layer provided between the non-magnetic support and the magnetic layer and containing a non-magnetic powder, and a back coat layer formed on the other surface of the non-magnetic support, wherein the non-magnetic powder is goethite particles having an average particle size in a range of from 5 nm to 100 nm and the magnetic tape has an edge weave amount of 1.0 μm or less.

This application claims priority to Japanese Patent Application No. 2004-033902, which is herein incorporated by reference in its entirety.

### BACKGROUND OF THE INVENTION

1. Field of the Invention

The present invention relates to a magnetic tape having good high recording density characteristics and good storage stability.

2. Description of the Background Art

Magnetic tapes have various applications such as audio tapes, video tapes, computer tapes, etc. In the field of magnetic tapes for data-backup, with the increase of the capacity of a hard disc to be duplicated, magnetic tapes having a recording capacity of 200 GB or more per reel have been commercialized. Large capacity backup tapes having a capacity exceeding 1 TB are proposed, and thus the recording density of the magnetic tapes should be further increased.

To produce a magnetic tape responding to the increase of a recording density, highly advanced technologies such as the micronization of magnetic powder or magnetic particles, the high density filling of such magnetic powder in a magnetic layer, the smoothening of a magnetic coating film and the reduction of a thickness of a magnetic layer are used to cope with the reduction of a wavelength of recording signals.

To increase a recording density, a track pitch is decreased besides the reduction of the wavelength of recording signals. Furthermore, a system using a servo track appears so that a reproducing magnetic head can accurately trace the track.

A magnetic tape runs in such a state that the position of one longitudinal edge of the magnetic tape is restricted in a tape-width direction by the inner face of a flange of a guide roller provided in a magnetic recording-reproducing equipment. As shown in FIG. 1 including the partly enlarged schematic view of a tape edge, the tape edge 3a of the magnetic tape 3 has wave-form unevenness, which is formed by the waving of an edge in the transverse direction of the magnetic tape along the machine direction of the tape. This unevenness of the tape edge is also named edge weave or edge wave. Therefore, the tape position in the transverse direction changes very slightly, even though the magnetic tape 3 runs along the inner face of the flange which serves as a running reference. However, when the servo-tracking system described above is used, a magnetic head as a whole shifts in the transverse direction of the magnetic tape even when the position of the magnetic tape changes even very slightly in the transverse direction. Accordingly, the recording-reproducing magnetic head always reaches a correct data track.

Since a track pitch has been further decreased, it is required for the linearity of the magnetic tape to be excellent, that is, an amount of edge wave (the distance α in FIG. 1) should be small so as to operate the servo-tracking more precisely (see JP-A-2001-184627 and JP-A-2002-269711).

With the reduction of the thickness of a magnetic layer and the narrowing of a track pitch, the higher sensitivity of a magnetic head is required, and thus a magnetoresistance effect (MR) head is used as a reproducing head. The MR head is often used in a current drive for a computer, and used in combination with a magnetic induction type recording head. Since the MR head is made of different materials and has a different shape from the conventional magnetic heads, a magnetic coating layer is preferably designed to accommodate the MR head.

In the case of reducing the thickness of a magnetic layer, a non-magnetic primer layer is provided between a non-magnetic support and the magnetic layer to smoothen the surface of the magnetic layer and to uniform the thickness of the magnetic layer. To form a smooth magnetic layer, it is preferable to smoothen the interface between the magnetic layer and the non-magnetic layer. Thus, non-magnetic powder to be contained in the non-magnetic layer is investigated (see JP-A-11-3517 and JP-A-2003-296920).

However, the conventional techniques cannot provide any magnetic tape that is excellent both in the high recording density characteristics and in the durability and storageability, and also has good servo-tracking characteristics.

JP-A-2001-184627 and JP-A-2002-269711 disclose a magnetic tape having small edge weave and thus achieving good output and small fluctuation of output, but they do not take the durability and storageability of the magnetic tape into consideration. JP-A-11-3517 and JP-A-2003-296920 disclose a magnetic tape which comprises a primer layer containing goethite and has good output and durability, but they neither take servo-tracking into consideration nor refer to the improvement of edge weave.

### SUMMARY OF THE INVENTION

An object of the present invention is to provide a magnetic tape which comprises a primer layer containing fine goethite particles, has excellent high recording density characteristics, good durability and good servo-tracking characteristics.

According to the present invention, the above object is achieved by a magnetic tape comprising a non-magnetic support, a magnetic layer formed on one surface of the non-magnetic support and containing a magnetic powder, a primer layer provided between the non-magnetic support and the magnetic layer and containing a non-magnetic powder, and a back coat layer formed on the other surface of the non-magnetic support, wherein the non-magnetic powder is goethite particles having an average particle size in a range of from 5 nm to 100 nm and the magnetic tape has an edge weave amount of 1.0 μm or less.

### BRIEF DESCRIPTION OF THE DRAWINGS

FIG. 1 is a plan view of apart of a magnetic tape, illustrating the edge weave formed on the magnetic tape in an enlarged state.

FIG. 2 schematically illustrates an example of a simplified slitting system used for slitting a magnetic sheet to produce a magnetic tape of the present invention.

FIG. 3 is a partial sectional view of a tension cut roller arranged in the slitting system of FIG. 2, schematically illustrating a part of the sucking portions.

### DETAILED DESCRIPTION OF THE INVENTION

As described above, to cope with the recent trend toward the high recording density, the ultra-fine particles of magnetic powder are contained in the magnetic layer, and the MR head is used as a reproducing head. The MR head comprises a MR element which is softer than an element constituting the conventional induction type magnetic head. Therefore, the MF head is designed such that the MR element part slightly dents from the surrounding surface of the MR head in view of the life of the MR head. As the magnetic tape runs over the MR head for a long time, the depth of such dent increases and, in turn, the distance between the magnetic layer and the MR element increases. As a result, a reproducing output decreases. Thus, a magnetic tape which is reproduced with the MR head is designed to have lower abrasion properties against the head than the conventional magnetic tape. Accordingly, an ability of the magnetic tape to remove the contaminations adhered to the head deteriorates, so that the head contamination increases. The head contamination is remarkable when the magnetic tape is traveled for a long time under high-temperature and high-humidity conditions, or when the magnetic tape is traveled for a long time after it is stored under high-temperature and high-humidity conditions. When the components of the head contamination were analyzed, a large amount of iron was detected. As a result of the further study to decrease the head contamination, it has been found that the head contamination can be reduced when the primer layer contains the particles of goethite (hydrated iron hydroxide) having an average particle size of from 5 nm to 100 nm. When the average particle size of goethite is outside this range, the surface of the primer layer is roughened and, in turn, the surface of the magnetic layer is roughened and also the fluctuation of the interface between the magnetic layer and the primer layer increases, so that the electromagnetic conversion characteristics of the magnetic tape deteriorates, since it is difficult to disperse the goethite particles in a medium of a primer coating composition when the average particle size of goethite is less than 5 nm, or the shape-effect of the particles appears when the average particle size of goethite exceeds 100 nm. In the present invention, the goethite particles are preferably used as a non-magnetic powder to be contained in the primer layer, because goethite is produced without any firing step at a high temperature, so that the particles are less sintered together and the fine particle goethite can be stably produced, and therefore the primer layer has a smooth surface, and also because the goethite particles cause less head contamination since the amount of Fe ions soluble in water is smaller than that of hematite (α-iron oxide) and thus the amount of exuded Fe ions onto the surface of the magnetic layer is small under high-temperature and high-humidity conditions.

The shape of goethite particles is not particularly limited, and is preferably a needle form or a plate form. When the goethite particles are in the form of a needle or a plate, they are oriented in a machine direction or a plane direction when the primer coating composition is applied on the non-magnetic support, and thus the surface of the primer layer is easily smoothened. When the primer layer has the smooth surface, the thickness of the magnetic layer can be made uniform and the coating irregularity of the magnetic layer is suppressed. Accordingly, when the non-magnetic support carrying the primer layer and the magnetic layer, that is, the magnetic sheet is wound, the surface of the magnetic sheet has neither streaks nor irregularities, and thus, a magnetic tape having a decreased edge weave amount can be produced by slitting the magnetic sheet to produce a tape having a desired width.

With the increase of the recording density of the magnetic tape, a track pitch is also narrowed. Therefore, a system using a servo-track is commercialized so that the reproducing head can accurately trace the recorded track. When a track pitch is about 24 μm or larger, the servo-tracking can be carried out without problem even if the edge weave amount is about 3 μm. However, when the track pitch is 21 μm or less, in particular, 15 μm or less, the servo-tracking cannot be sufficiently carried out if the edge weave amount is large. Therefore, the edge weave amount is preferably 1 μm or less, more preferably 0.8 μm or less. Ideally, the edge weave amount is 0 μm. When the edge weave amount exceeds the above limit, the servo control may not be effectively carried out and the reproducing head causes track misalignment so that errors increase.

To decrease the edge weave amount of the magnetic tape, conventional methods can be used. For example, the needle- or plate-form magnetic powder is added to the primer layer to suppress the deformation of the magnetic sheet as described above, the viscosities of the coating compositions of the layers are controlled when the magnetic layer is formed on the primer layer by a wet-on-wet method so as to suppress the fluctuation of the interface between the layers, elements of a slitting machine used to slit the magnetic sheet to magnetic tapes are selected so that the vibration or the fluctuation of tension is decreased. When some of those methods are combined to control the edge weave amount in the above range.

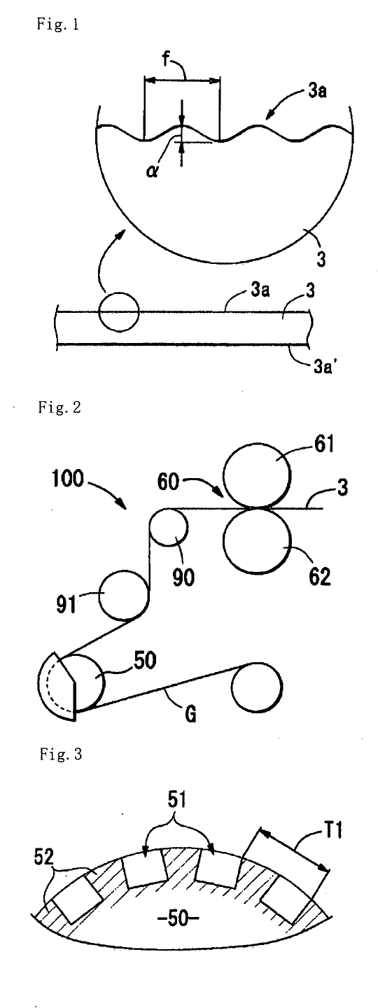

With regard to the improvement of a slitting machine, there are various improvement of elements of the slitting machine. For example, in the slitting machine 100 shown in FIG. 2, the improvements include the improvement of the tension cut roller 50 disposed in the web route through which the magnetic sheet drawn out reaches the group of slitting blades 61, 62 in the blade-driving unit 60, the improvement of a timing belt coupling (not shown) for transmitting power to the blade-driving unit 60, the suppression of the mechanical vibrations of the blade-driving unit 60, and so on. In FIG. 2, numerals 90 and 91 indicate guides provided in the running route of the magnetic sheet G. Among those improvements, one that is most effective for the decrease of the amount of edge weave with a short cycle (a cycle “f” in FIG. 1) of, for example, 50 mm or less is the use of a mesh suction roller. That is, a mesh suction roller having suction holes 51 made of a porous material shown in FIG. 3 is used as the tension cut roller 50, which is used to control the tension of the magnetic sheet. In FIG. 3, the suction roller comprises the suction holes 51 which are communicated with a suction source (not shown) to suck the magnetic sheet, and the tape-contacting portions 52 which are in contact with the magnetic sheet, in which the holes 51 and the portions 52 are alternately disposes at regular intervals alongside the outer peripheral surface of the suction roller 50. To decrease the amount of edge weave with a medium cycle of 60 to 70 mm, it is effective to use a flat belt as a timing belt (not shown) for transmitting power to the blade-driving unit or to use a rubber coupling in place of a metal coupling.

To decrease the amount of edge weave having a relatively long cycle of 80 to 90 mm, it is effective to directly drive the blade-driving unit with a motor without using any power-transmitting unit.

The tracking performance can be improved by prolonging the cycle of edge weave of the magnetic tape to, for example, 160 mm or longer at which no off-track is induced even at a tape-feeing speed of 8 mm/sec. or larger, since the edge weave having such along cycle has less adverse effects on the servo-tracking, although the amount of edge weave itself is not small.

Hereinafter, the components of the magnetic tape of the present invention will be described in detail.

<Non-Magnetic Support>

The thickness of the non-magnetic support of the magnetic tape according to the present invention depends on the applications of the magnetic tape. The thickness of the non-magnetic support is generally 1.5 to 11.0 μm, preferably 2.0 to 7.0 μm, more preferably 2.0 to 5.0 μm. When the thickness of the non-magnetic support is less than 1.5 μm, it is difficult to produce such a thin film. When the thickness of the non-magnetic support exceeds 11.0 μM, the total thickness of the magnetic tape increases so that a recording capacity per reel decreases.

The Young's modulus of the non-magnetic support in a machine direction is preferably at least 5.8 GPa (590 kg/mm²), more preferably at least 7.1 GPa (720 kg/mm²). When the Young's modulus in the machine direction is less than 5.8 GPa (590 kg/mm²), the tape running is destabilized.

In the case of a helical scanning type head, a ratio of a Young's modulus in the machine direction to that in the transverse direction of the magnetic tape is preferably from 0.60 to 0.80, more preferably 0.65 to 0.75. When this ratio is less than 0.60 or larger than 0.80, the variation of output increases between the entrance and exit of the magnetic head (i.e. flatness) may increase. Such a variation is minimized when the above ratio is about 0.70. Furthermore, in the case of a linear recording type head, the ratio of a Young's modulus in the machine direction to that in the transverse direction of the magnetic tape is preferably from 0.70 to 1.30.

The non-magnetic support preferably has a coefficient of thermal expansion of −10 to +10×10⁻⁶ in the transverse direction, more preferably 0 to +10×10⁻⁶. When the coefficient of thermal expansion in the machine direction is outside this range, the off-track (the tracking misalignment of the reproducing head) is caused by the change of temperature and/or humidity so that an error rate increases.

Examples of the non-magnetic support satisfying the above properties include biaxially stretched films of polyethylene terephthalate, polyethylene naphthalate, aromatic polyamide, aromatic polyimide, etc.

<Primer Layer>

The primer layer preferably has a thickness of 0.2 to 1.5 μm, more preferably 1.0 μm or less, particularly preferably 0.8 μm or less. When the thickness of the primer layer is less than 0.2 μm, the fluctuation of the thickness of the magnetic layer is not sufficiently suppressed, and the durability is not satisfactorily increased. When the thickness of the primer layer exceeds 1.5 μm, the total thickness of the magnetic tape increases so that a recording capacity per reel decreases.

In the present invention, the primer layer contains goethite (FeOOH) as a nom-magnetic powder. In addition to goethite, the primer layer may optionally contain other metal oxyhydride such as an oxyhydride of a transition metal, for example, indium oxyhydride (InOOH), manganese oxyhydride (MnOOH), nickel oxyhydride (NiOOH), etc., aluminum oxyhydride (AlOOH) or their complex metal hydroxides.

Aluminum, silicon or a rare earth element is preferably adhered to the goethite particles, since the dispersibility of the goethite particles in the primer paint is improved.

The particle shape of the non-magnetic powder may be plate-form, needle-form or spindle-form. When the particles of the non-magnetic powder are plate- or needle-form, the surface of the primer layer is further smoothened.

The particle size of the non-magnetic powder is expressed as the maximum size of the particle, and the number average particle size of the non-magnetic powder is preferably from 5 nm to 100 nm. The non-magnetic powder may optionally be used in combination with carbon black having a particle size of 0.01 to 0.1 μm and/or aluminum oxide powder having a particle size of 0.05 to 0.5 μm. Preferably, the non-magnetic powder and carbon black have a narrow particle size distribution to apply the primer paint smoothly without leaving the thickness irregularity.

To improve the conductivity of the primer layer, the primer paint may contain plate-form carbonaceous powder having an average particle size of 10 to 100 nm, such as graphite, or plate-form ITO (indium-tin complex oxide) powder having an average particle size of 10 to 100 nm. The addition of such plate-form non-magnetic powder can improve the evenness of thickness, surface smoothness, stiffness, dimensional stability against temperature/humidity change of the primer layer.

The average particle size of the non-magnetic powder or other powders such as carbon black, etc. is determined by taking a photograph of particles with a transmission electron microscope at a sufficient magnification for observing the shape of each particle, measuring the largest particle size (a major axis length in case of a needle-form particle) of each of 100 particles, and then number averaging the measured particle sizes.

A binder resin to be contained in the primer layer may be the same as one contained in the magnetic layer, which will be explained later.

<Lubricant>

The primer layer preferably contains 0.5 to 5.0% by weight of a higher fatty acid and 0.2 to 3.0% by weight of an ester of a higher fatty acid ester, based on the total weight of the powders contained in the primer layer and the magnetic layer, since a coefficient of friction against the head is decreased. When the amount of the higher fatty acid is less than 0.5% by weight, the coefficient of friction may not be sufficiently decreased. When the amount of the higher fatty acid exceeds 5.0% by weight, the primer layer is plasticized so that the stiffness of the layer may be lost. When the amount of the ester of the higher fatty acid is less than 0.2% by weight, the coefficient of friction may not be sufficiently decreased. When the amount of the ester of the higher fatty acid exceeds 3.0% by weight, an excessive amount of the ester migrates into the magnetic layer so that some problems such as the sticking of the magnetic tape to the head may arise.

The higher fatty acid is preferably a fatty acid having at least 10 carbon atoms, and the ester of the higher fatty acid is an ester of such a fatty acid having at least 10 carbon atoms. The fatty acid having at least 10 carbon atoms may be linear or branched one, and any one of cis- and trans-isomers. Among them, the linear fatty acids are preferable because of the excellent lubricity. Specific examples of such fatty acids include lauric acid, myristic acid, stearic acid, palmitic acid, behenic acid, oleic acid, linoleic acid, etc. Among them, myristic acid, stearic acid and palmitic acid are preferable.

The amount of the fatty acid contained in the magnetic layer is not limited since the fatty acid migrates between the magnetic layer and the primer layer. The total amount of the fatty acid contained in the magnetic layer and the primer layer is adjusted in the above range. When the fatty acid is contained in the primer layer, it may not always be added to the magnetic layer.

Preferably, the magnetic layer contains 0.5 to 3.0% by weight of a fatty acid amide and 0.2 to 3.0% by weight of the ester of the higher fatty acid, each based on the weight of the magnetic powder, since the coefficient of friction during the traveling of the magnetic layer is reduced.

When the amount of the fatty acid amide is less than 0.5% by weight, the head and the magnetic layer tend to be in direct contact to each other at their interface so that the seizing may not be sufficiently prevented. When the amount of the fatty acid amide exceeds 3.0% by weight, the fatty acid amide may bleed out to cause some defects such as dropout. Examples of the fatty acid amide include amides of fatty acids having at least 10 carbon atoms such as palmitic acid, myristic acid, etc.

When the amount of the ester of the higher fatty acid is less than 0.2% by weight, the coefficient of friction may not be sufficiently decreased. When the amount of the ester of the higher fatty acid exceeds 3.0% by weight, some problems such as the sticking of the magnetic tape to the head may arise.

The intermigration of the lubricants of the magnetic layer and the primer layer between them may not be excluded.

The non-magnetic powder, carbon black, etc. in the primer layer, and the magnetic powder in the magnetic layer may be surface-treated with a dispersant, or processed in the presence of a dispersant to prepare the paint. Examples of the dispersant include a fatty acid having 12 to 18 carbon atoms represented by the formula:
RCOOH
wherein R is an alkyl or alkenyl group having 11 to 17 carbon atoms, such as caprylic acid, capric acid, lauric acid, myristic acid, palmitic acid, stearic acid, behenic acid, oleic acid, elaidic acid, linoleic acid, linolenic acid, stearolic acid, etc., meal soaps comprising the alkali metal or alkaline metal salts of such fatty acids, fluorine-containing derivatives of the esters of such fatty acids, amides of such fatty acids, polyalkylene oxide alkylphosphates, lecithin, trialkylpolyolefinoxy quaternary ammonium salts wherein the alkyl moiety has 1 to 5 carbon atoms and the olefin may be ethylene, propylene, etc., sulfate salts, sulfonate salts, phosphate salts, copper phthalocyanine, etc. These dispersants may be used singly or as a mixture of two or more of them. The amount of the dispersant in each layer is preferably from 0.5 to 20 parts by weight per 100 parts by weight of the binder resin.

<Magnetic Layer>

The magnetic layer preferably has a thickness of 0.01 to 0.15 μm. When the thickness of the magnetic layer is less than 0.01 μm, the output obtained is small and it is difficult to form a uniform magnetic layer. When the thickness of the magnetic layer exceeds 0.15 μm, the resolution of signals with a short wavelength may be worsened.

To improve the recording characteristics at the short wavelength, the thickness of the magnetic layer is more preferably from 0.01 to 0.1 μm, most preferably from 0.02 to 0.06 μm.

The magnetic layer preferably has a coercive force of 80 to 320 kA/m, more preferably 100 to 300 kA/m, particularly preferably 120 to 280 kA/m. When the coercive force is less than 80 kA/m, the output may be decreased by diamagnetic filed demagnetization, when the recording wavelength is shortened. When the coercive force exceeds 320 kA/m the recording of the magnetic tape with the magnetic head becomes difficult.

A binder resin to be contained in the magnetic layer and also in the primer layer is preferably a combination of a polyurethane resin and at least one resin selected from the group consisting of vinyl chloride resins, vinyl chloride-vinyl acetate copolymers, vinyl chloride-vinyl alcohol copolymers, vinyl chloride-vinyl acetate-vinyl alcohol copolymers, vinyl chloride-vinyl acetate-maleic anhydride copolymers, vinyl chloride-hydroxyl group containing alkyl acrylate copolymers, and cellulose resins such as nitrocellulose. Among them, the combination of a polyurethane resin and a vinyl chloride-hydroxyl group containing alkyl acrylate copolymer is preferably. Examples of the polyurethane resin include polyester polyurethane resins, polyether polyurethane resins, polyetherpolyester polyurethane resins, polycarbonate polyurethane resins, polyesterpolycarboante polyurethane resins, etc.

Preferably, a resin having a functional group such as —COOH, —SO₃M, —OSO₃M, —P═O(OM)₃, —O—P═O(OM)₂ wherein M is a hydrogen atom, an alkali metal base or an amine salt; —OH, —NR¹R², —N⁺R³R⁴R⁵ wherein R¹, R², R³, R⁴ and R⁵ are the same or different, each independently a hydrogen atom or a hydrocarbon group; or an epoxy group is used as a binder resin, since such a resin can improve the dispersibility of the magnetic powder and other powder. When two or more resins are used in combination, they preferably have the same functional group. In particular, the combination of resins both having —SO₃M groups is preferable.

The binder resin is preferably used in an amount of 7 to 50 parts by weight, more preferably from 10 to 35 parts by weight, per 100 parts by weight of the magnetic powder in the magnetic layer, or based on 100 parts by weight of the non-magnetic powder in the primer layer. In particular, the best combination as the binder for the magnetic layer and/or the primer layer is a mixture of 5 to 30 parts by weight of a vinyl chloride-based resin and 2 to 20 parts by weight of a polyurethane resin.

It is preferable to use the binder together with a thermally curable crosslinking agent which bonds with the functional groups in the binder resin to crosslink the resin. Preferable examples of the crosslinking agent include isocyanates such as tolylene diisocyanate, hexamethylene diisocyanate and isophorone diisocyanate; and polyisocyanates such as reaction products of these isocyanates with compounds each having a plurality of hydroxyl groups such as trimethylolpropane, and condensation products of these isocyanates, etc. The crosslinking agent is used in an amount of usually 1 to 30 parts by weight, preferably 5 to 20 parts by weight, based on 100 parts by weight of the binder resin. If the amount of the crosslinking agent contained in the magnetic layer is decreased, for example, to 0 part by weight, no problem arises because the crosslinking agent is dispersed and supplied from the primer layer, and thus, the binder resin in the magnetic layer can be crosslinked to some extent.

A radiation-curable resin may be used in addition to or in place of the thermally curable binder resins described above. Examples of the radiation-curable resin include resins prepared by acrylic-modifying the above thermally curable resins to form radiation-sensitive double bonds in the resin backbones, acrylic monomers, acrylic oligomers, etc.

The magnetic powder contained in the magnetic layer preferably has an average particle size of 5 nm to less than 60 nm, more preferably 10 to 40 nm. When the average particle size of the magnetic powder is less than 5 nm, the particles have a large surface energy so that the dispersion of the particles becomes difficult. When the average particle size of the magnetic powder is 60 nm or more, the noise increases.

Preferable examples of the magnetic powder include ferromagnetic iron-based metal magnetic powder, iron nitride magnetic powder, etc.

The ferromagnetic iron-based metal magnetic powder may optionally contain at least one transition metal such as Mn, Zn, Ni, Cu, Co, etc. in the form of an alloy with iron. Among them, Co and Ni are preferable. In particular, Co is preferable since it can most effectively increase the saturation magnetization of the magnetic powder. The amount of the transition metal is preferably from 5 to 50 atomic %, more preferably from 10 to 30 atomic %, based on the amount of iron.

Furthermore, the ferromagnetic iron-based metal magnetic powder may contain at least one rare earth element selected from the group consisting of yttrium, cerium, ytterbium, cesium, praseodymium, samarium, lanthanum, europium, neodymium, terbium, etc. as a component for preventing sintering. Among them, cerium, neodymium, samarium, terbium and ytterbium are preferable, since the particle shape of the magnetic powder is restored and a uniform ceramic layer is formed on the surfaces of the magnetic powder particles, when they are used. The amount of the rare earth element is preferably from 0.2 to 25 atomic %, more preferably from 0.3 to 20 atomic %, particularly preferably from 0.5 to 15 atomic %, based on the amount of iron.

The iron nitride magnetic powder may be a conventional one, and may have a needle shape and also a spherical shape or an irregular shape such as a cube. To produce the iron nitride magnetic powder having the particle size and specific surface area satisfying the requirements as the magnetic powder, the production conditions should be selected (see JP-A-2000-277311). That is, such an iron nitride magnetic powder can be produced as follows:

An iron oxide powder such as γ-Fe₂O₃ or a metal-iron oxide comprising such an iron oxide powder, which has a particle size of 0.5 μm or less, is reduced in a hydrogen atmosphere and then nitrided in an atmosphere of ammonia (NH₃) or a mixed gas stream containing ammonia gas.

The reduction of the iron oxide powder or metal-iron oxide powder is preferably carried out in the stream of hydrogen gas at a temperature of 300 to 500° C. When the reducing temperature is less than 300° C., the oxide powder is insufficiently reduced and thus any magnetic powder having a large saturation magnetization may not be obtained after the nitriding step. When the reducing temperature exceeds 500° C., the particles may be sintered together and thus any magnetic powder having a large coercive force may not be obtained after the nitriding step.

The nitriding of the reduced powder is preferably carried out in the atmosphere of ammonia or a mixed gas stream containing ammonia gas and at least one diluent gas such as argon, hydrogen, nitrogen, etc. at a relatively low temperature of 100 to 250° C. When the nitriding temperature is too high, any Fe₁₆N₂ phase may be formed. When the nitriding temperature is too low, the formation rate of the Fe₁₆N₂ phase tend to decrease. These gases preferably have high purity (5 N or higher) or contains oxygen in an amount of several ppm.

The ferromagnetic iron-based metal magnetic powder or the iron nitride magnetic powder preferably has a coercive force of 80 to 320 kA/m, and a saturation magnetization of 80 to 200 A·m²/kg (80 to 200 emu/g), more preferably 100 to 180 A·m²/kg (100 to 180 emu/g).

The ferromagnetic iron-based metal magnetic powder or the iron nitride magnetic powder preferably has an average particle size of 5 nm to less than 60 nm, more preferably 15 to 40 nm. When this average particle size is less than 5 nm, the coercive force may decrease or the dispersion of the magnetic powder in the magnetic paint may be difficult. When this average particle size is 60 nm or more, the particle noise due to the size of the powder particles increases. The ferromagnetic power preferably has a BET specific surface area of at least 35 m²/g, more preferably at least 40 m²/g, most preferably at least 50 m²/g. Usually, the BET specific surface area does not exceed 100 m²/g.

The particle surface of the ferromagnetic iron-based metal magnetic powder or the iron nitride magnetic powder may be coated with Al, Si, P, Y or Zr, or the oxide thereof.

The magnetic characteristics of the magnetic layer and the ferromagnetic powder are measured with a sample-vibration type fluxmeter under an external magnetic field of 1273.3 kA/m (16 kOe).

The magnetic layer may optionally contain an abrasive. The abrasive is preferably one having a Mohs hardness of at least 6, and examples of such an abrasive include α-alumina, β-alumina, silicon carbide, chromium oxide, cerium oxide, α-iron oxide, corundum, artificial diamond, silicon nitride, titanium carbide, titanium oxide, silicon dioxide, boron nitride, etc. They may be used independently or as a mixture thereof. The abrasive preferably has an average particle size of 10 to 200 nm.

If desired, the magnetic layer may contain carbon black (CB) to improve the conductivity and the surface lubricity. As this carbon black, acetylene black, furnace black, thermal black, etc. may be used. Carbon black preferably has an average particle size of 10 to 100 nm. When the average particle size of carbon black is less than 10 nm, the dispersion of the carbon black particles in the magnetic paint is difficult. When the particle size of carbon black exceeds 100 nm, a large amount of carbon black should be added. In either case, the surface of the magnetic layer is roughened and thus the output tends to decrease. If necessary, two kinds of carbon black having different average particle sizes may be used.

<Back Coat Layer>

A back coat layer is formed on the other surface of the non-magnetic support, which is the opposite surface to the surface carrying the magnetic layer formed, to improve the running performance of the magnetic tape. The back coat layer preferably has a thickness of 0.2 to 0.8 μm. When the thickness of the back coat layer is less than 0.2 μm, the tape-running performance may not be sufficiently improved. When the thickness of the back coat layer exceeds 0.8 μm, the total thickness of the magnetic tape increases so that a recording capacity per reel decreases.

The back coat layer preferably contains carbon black in order to improve the tape-running performance. Carbon black to be contained in the back coat layer may be acetylene black, furnace black, thermal black, etc. In a preferred embodiment, carbon black with a small particle size and carbon black with a large particle size are used in combination. The particle size of small particle size carbon black is preferably from 5 to 100 nm, more preferably from 10 to 100 nm. When the particle size of the small particle size carbon black is less than 10 nm, the dispersion thereof is difficult. When the particle size of the small particle size carbon black exceeds 100 nm, a large amount of carbon black is necessary. In either case, the surface of the back coat layer is roughened and thus the surface roughness of the back coat layer may be transferred to the magnetic layer (embossing). When the large particle size black carbon having a particle size of 200 to 400 nm is used in an amount of 5 to 15% by weight based on the weight of the small particle size carbon black, the surface of the back coat layer is not roughened and the effect to improve the tape-running performance is enhanced. The total amount of the small particle size carbon black and the large particle size carbon black is preferably from 60 to 100% by weight, more preferably from 70 to 100% by weight, based on the weight of a whole of the inorganic powder.

The center line average surface roughness Ra of the back coat layer is preferably from 3 to 15 nm, more preferably from 4 to 10 nm.

If the back coat layer has magnetism, the magnetic signals of the magnetic layer may be disturbed. Thus, the back coat layer is usually non-magnetic.

To improve the strength and the size stability against temperature/humidity change and to reduce the edge weave amount, the back coat layer may optionally contain a plate-form non-magnetic powder with a particle size of 10 to 100 nm. The non-magnetic powder may be aluminum oxide powder and also an oxide or a composite oxide of rare earth elements (e.g. cerium, etc.), zirconium, silicon, titanium, manganese, iron, etc. Furthermore, the back coat layer may contain a plate-form carbonaceous powder having an average particle size of 10 to 100 nm or a plate-form ITO powder having an average particle size of 10 to 100 nm to improve the conductivity of the layer. If necessary, the back coat layer may contain iron oxide particles having an average particle size of 0.1 to 0.6 μm.

The amount to the above optional powder or powders is preferably from 2 to 40% by weight, more preferably from 5 to 30% by weight based on the weight of the whole inorganic powders contained in the back coat layer.

Particularly preferably, alumina (aluminum oxide) having an average particle size of 0.1 to 0.6 μm is used, since the durability of the layer is further improved.

As a binder to be contained in the back coat layer, the same resins as those used in the magnetic layer and the primer layer can be used. Among them, the use of a cellulose resin in combination with a polyurethane resin is preferable to decrease the coefficient of friction and to improve the tape-running performance. The amount of the binder in the back coat layer is usually from 40 to 150 parts by weight, preferably from 50 to 120 parts by weight, more preferably from 60 to 110 parts by weight, still more preferably from 70 to 110 parts by weight, based on total 100 parts by weight of the carbon black and the inorganic non-magnetic powder. When the amount of the binder is less than 50 parts by weight, the strength of the back coat layer is insufficient. When the amount of the binder exceeds 120 parts by weight, the coefficient of friction tends to increase. Preferably, 30 to 70 parts by weight of a cellulose resin and 20 to 50 parts by weight of a polyurethane resin are used in combination.

To cure the binder, a crosslinking agent such as a polyisocyanate compound is preferably used. The crosslinking agent to be contained in the back coat layer may be the same as those used in the magnetic layer and the primer layer. The amount of the crosslinking agent is usually from 10 to 50 parts by weight, preferably from 10 to 35 parts by weight, more preferably from 10 to 30 parts by weight, based on 100 parts by weight of the binder. When the amount of the crosslinking agent is less than 10 parts by weight, the film strength of the back coat layer tends to decrease. When the amount of the crosslinking agent exceeds 35 parts by weight, the coefficient of dynamic friction of the back coat layer against SUS increases.

<Organic Solvent>

An organic solvent may be used in the preparation processes of paints (coating compositions) for the formation of the magnetic layer, the primer layer and the back coat layer. Preferable examples of the organic solvent include ketones (e.g. methyl ethyl ketone, cyclohexanone, methyl isobutyl ketone, etc.), ethers (e.g. tetrahydrofuran, dioxane, etc.), acetates (.g. ethyl acetate, butyl acetate, etc.), and so on. These solvents may be used independently or as a mixture thereof. Furthermore, such an organic solvent may be used in combination with an aromatic solvent such as toluene.

### EXAMPLES

The present invention will be explained in detail by the following Examples, which do not limit the scope of the invention in any way. In Examples, “parts” are “parts by weight”, unless otherwise specified.

### Example 1

Components of Coating Composition for Primer Layer:

| | Parts |
|---|---|
| (1) | |
| Needle-form goethite powder | 64 |
| (Av. particle size: 45 nm; acicular ratio: 2.5; | |
| BET specific surface area: 63 m²/g; | |
| Al content: 0.2% by weight) | |
| Carbon black (Av. particle size: 25 nm) | 24 |
| Alumina (Av. particle size: 80 nm) | 12 |
| Stearic acid | 2.0 |
| Vinyl chloride-hydroxypropyl acrylate copolymer | 8.8 |
| (Content of —SO₃Na groups: 0.7 × 10⁻⁴ eq./g) | |
| Polyesterpolyurethane resin | 4.4 |
| (Tg: 40° C.; Content of —SO₃Na groups: 1 × 10⁻⁴ eq./g) | |
| Cyclohexanone | 25 |
| Methyl ethyl ketone | 40 |
| Toluene | 10 |
| (2) | |
| Butyl stearate | 1 |
| Cyclohexanone | 70 |
| Methyl ethyl ketone | 50 |
| Toluene | 20 |
| (3) | |
| Polyisocyanate | 1.4 |
| Cyclohexanone | 10 |
| Methyl ethyl ketone | 15 |
| Toluene | 10 |

Components of Coating Composition for Magnetic Layer:

| | Parts |
|---|---|
| (1): Kneading step | |
| Magnetic powder (Co—Fe—Al—Y) | 100 |
| (Co/Fe: 24 atomic %; Al/(Fe + Co): 4.7 atomic %; | |
| Y/(Fe + Co): 7.9 atomic %; σs: 127 A · m²/kg (127 emu/g); | |
| Hc: 177.1 kA/m (2225 Oe); av. particle size: 45 nm; | |
| acicular ratio: 4) | |
| Vinyl chloride-hydroxypropyl acrylate copolymer | 13 |
| (Content of —SO₃Na groups: 0.7 × 10⁻⁴ eq./g) | |
| Polyester polyurethane resin | 4.5 |
| (Content of —SO₃Na groups: 1 × 10⁻⁴ eq./g) | |
| Alumina (Av. particle size: 80 nm) | 8 |
| Carbon black (Av. particle size: 25 nm) | 5 |
| Methyl acid phosphate (MAP) | 2 |
| Tetrahydrofuran (THF) | 20 |
| Methyl ethyl ketone/cyclohexanone (MEK/A) | 9 |
| (2): Diluting step | |
| Palmitic acid amide (PA) | 1.5 |
| n-Butyl stearate (BS) | 1 |
| Methyl ethyl ketone/cyclohexanone (MEK/A) | 250 |
| (3) Blending step | |
| Polyisocyanate | 1.5 |
| Methyl ethyl ketone/cyclohexanone (MEK/A) | 129 |

A coating composition for a primer layer was prepared by kneading the components of Group (1) with a batch-type kneader, adding the components of Group (2) to the mixture and stirring them, dispersing the mixed components with a sand mill (zirconia beads having a particle diameter of 0.5 mm; charged at an apparent volume of 80%; peripheral speed of 8 m/sec.) for a residence time of 60 minutes, and adding the components of Group (3), followed by stirring and filtering the mixture.

Separately, a magnetic coating composition was prepared by previously mixing the components of Group (1) for the kneading step at a high velocity, kneading the mixed powder with a continuous two-screw kneader; adding the components of Group (2) for the diluting step and diluting the mixture at least in two stages with the continuous two-screw kneader to obtain a composition for primary dispersion; then dispersing the composition for primary dispersion with a sand mill (zirconia beads having a particle diameter of 0.5 mm; charged at an apparent volume of 80%; peripheral speed of 8 m/sec.) for a residence time of 50 minutes; and adding the components of Group (3) for the blending step to the primarily dispersed composition, followed by stirring and filtering the composition.

The coating composition for a primer layer was applied on anon-magnetic support made of an aromatic polyamide film (MICTRON manufactured by TORAY; thickness: 3.9 μm; Young's modulus in a machine direction (MD): 11 GPa; ratio of Young's modulus in a machine direction (MD) to Young's modulus in a machine direction (TD) (MD/TD): 0.7) so that the primer layer had a dry thickness of 0.6 μm after being dried and calendered.

Then, the magnetic coating composition was applied on the primer layer by a wet-on-wet method using an extrusion type coater so that the magnetic layer had a dry thickness of 0.06 μm after being oriented in a magnetic field, dried and calendered. After the orientation in the magnetic field, the magnetic layer was dried with a drier and IR irradiation to obtain a magnetic sheet.

The orientation in the magnetic field was carried out by arranging N—N opposed magnets (5 kG) in front of the drier, and arranging, in the drier, two pairs of N—N opposed magnets (5 kG) at an interval of 50 cm and at a position 75 cm before a position where the dryness of the layer was felt by one's fingers. The coating rate was 100 m/min.

Components of Coating Composition for Back Coat Layer:

| | Parts |
|---|---|
| Carbon black (av. particle size: 25 nm) | 9 |
| Carbon black (av. particle size: 350 nm) | 10 |
| Plate-form non-magnetic iron oxide particles | 10 |
| (av. particle size: 50 nm) | |
| Nitrocellulose | 45 |
| Polyurethane resin with —SO₃Na groups | 30 |
| Cyclohexanone | 260 |
| Toluene | 260 |
| Methyl ethyl ketone | 525 |

The components of a coating composition for a back coat layer were dispersed with a sand mill (zirconia beads having a particle diameter of 0.5 mm; charged at an apparent volume of 80%; peripheral speed of 8 m/sec.) for a residence time of 45 minutes, and then a polyisocyanate (15 parts) as a crosslinking agent was added to the mixture to obtain a coating composition for aback coat layer. After filtration, the coating composition for a back coat layer was directly applied to the other surface of the base film opposite to the surface on which the primer layer and the magnetic layer were formed, so that the resultant back coat layer had a dry thickness of 0.5 μm after being dried and calendered, and then, the back coat layer was dried to obtain the magnetic sheet coated with the back coat layer.

The magnetic sheet obtained in the above was planished with a seven-stage calender comprising metal rolls, at a temperature of 100° C. under a linear pressure of 196 kN/cm, and wound around a core and aged at 70° C. for 72 hours. After that, the magnetic sheet was slit into tapes each having a width of 1/2 inch.

The components of a slitting machine (a machine for slitting a magnetic sheet into magnetic tapes with a predetermined width) were adapted as follows:

The tension cut roller was adapted into a tension cut roller of mesh suction type in which a porous metal was embedded in the sucking portions. The tension cut roller thus adapted was disposed in the web route through which the unwound magnetic sheet run towards a group of blades. The blade-driving unit was directly connected to a motor without any power-transmitting mechanism, so that the unit could be directly driven.

A tape obtained by slitting the magnetic sheet was fed at a rate of 200 m/min. while the surface of the magnetic layer thereof was being polished with a lapping tape and a blade, and wiped to finish a magnetic tape. In this step, K10000 was used as the lapping tape; a carbide blade was used as the blade; and Toraysee (trade name) manufactured by TORAY was used to wipe the surface of the magnetic layer. The above treatment was carried out under a feeding tension of 0.294 N.

A servo signal was written on the back coat layer of the magnetic tape using a servo-writer for S-DLT (Super Digital Linear Tape), and then the magnetic tape was run while the back coat layer was being in contact with a piece of velvet grafted with threads each having a length of 2.5 mm and comprising four twisted cotton yarns having a staple fiber diameter of 4 μm to remove burnt residues formed during the writing of a servo signal.

Thereafter, the magnetic tape was set in a cartridge to provide a magnetic tape cartridge (hereinafter referred to as a computer tape).

### Example 2

A computer tape of Example 2 was produced in the same manner as in Example 1 except that needle-form goethite particles having an average particle size of 70 nm, an acicular ratio of 3.5, a BET specific surface area of 48 m²/g and an aluminum content of 0.5% by weight were used in place of the goethite particles having an average particle size of 45 nm, an acicular ratio of 2.5, a BET specific surface area of 63 m²/g and an aluminum content of 0.2% by weight.

### Example 3

A computer tape of Example 3 was produced in the same manner as in Example 1 except that needle-form goethite particles having an average particle size of 100 nm, an acicular ratio of 4.0, a BET specific surface area of 46 m²/g and an aluminum content of 0.6% by weight were used in place of the goethite particles having an average particle size of 45 nm, an acicular ratio of 2.5, a BET specific surface area of 63 m²/g and an aluminum content of 0.2% by weight.

### Comparative Example 1

A computer tape of Comparative Example 1 was produced in the same manner as in Example 1 except that needle-form hematite particles having an average particle size of 110 nm, an acicular ratio of 6.1 and a BET specific surface area of 55 m²/g were used in place of the goethite particles having an average particle size of 45 nm, an acicular ratio of 2.5, a BET specific surface area of 63 m²/g and an aluminum content of 0.2% by weight, and that a blade-driving unit with a timing belt was used instead of the direct drive type blade-driving unit.

### Comparative Example 2

A computer tape of Comparative Example 2 was produced in the same manner as in Example 3 except that the porous metal embedded in the sucking portions of the slitting machine was removed.

### Comparative Example 3

A computer tape of Comparative Example 3 was produced in the same manner as in Comparative Example 2 except that needle-form goethite particles having an average particle size of 110 nm, an acicular ratio of 7, a BET specific surface area of 85 m²/g and an aluminum content of 4.3% by weight were used in place of the goethite particles having an average particle size of 45 nm, an acicular ratio of 2.5, a BET specific surface area of 63 m²/g and an aluminum content of 0.2% by weight.

The properties of the above computer tapes were evaluated as follows.

<C/N Measurement>

A drum tester was used to measure the electromagnetic conversion characteristics of the computer tapes. The drum tester was equipped with an electromagnetic induction type head (track width: 25 μm, and gap: 0.2 μm) for use in recoding and a MR head (track width: 8 μm) for use in reproducing. Both the heads were disposed at different positions relative to a rotary drum, and were vertically operated to hold pace with each other in tracking. A certain length of the magnetic tape was unwound from the wound magnetic tape in the cartridge and cut away, and a further 60 cm of the magnetic was unwound and shaped into a strip with a width of 4 mm, which was then wound around the rotary drum.

Outputs and noises were determined as follows:

A rectangular wave with a wavelength of 0.2 μm was written on the tape with a function generator, and an output from the MR head was amplified with a preamplifier and then read onto a spectrum analyzer. A value of a carrier wave with a wavelength of 0.2 μm was defined as an output C from the magnetic tape.

On the other hand, a noise value N was determined as follows:

When the rectangular wave with a wavelength of 0.2 μm was written on the tape, a difference obtained by subtracting an output and a system noise was integrated, and the resultant integration value was used as the noise value N. The ratio of an output from the magnetic tape to a noise, C/N, was determined. The values of C and C/N were determined as relative values based on the values obtained from the tape of Comparative Example 1 used as a reference.

<Surface Roughness of Magnetic Layer>

The surface roughness of the magnetic layer was measured with AFM (Dimension 3000 manufactured by Digital Instruments). The measurement was carried out in a tapping mode at ten points in a viewing field of 5 μm×5 μm square, and the measured values excluding the maximum and minimum values were arithmetically averaged to obtain a center line-average surface roughness Ra.

<Measurement of Edge Weave Amount>

An edge weave amount was continuously measured over a tape length of 50 m using an edge weave amount-measuring apparatus (KEYENCE) mounted on a servo writer at a running rate of 5 m/sec.

<Running Durability Test>

Using a S-DLT drive modified for use with a thin magnetic tape, the magnetic tape was written and reproduced at a recording wavelength of 0.37 μm in a test mode to measure an error rate. After that, the magnetic tape was run with all the tracks at a temperature of 40° C. and a humidity of 80% RH for 300 hours, and then an error rate was measured again.

<Storage Test>

The tape cartridge was stored at a temperature of 60° C. and a humidity of 80% RH for 240 hours and then at room temperature and atmospheric humidity for 24 hours. Thereafter, an error rate was measured in the same way as in the running durability test.

The results are summarized in Tables 1 and 2.

TABLE 1

| | Example No. | | |
|---|---|---|---|
| | 1 | 2 | 3 |
| Particle size of | 45 | 70 | 100 |
| non-magnetic powder (nm) | | | |
| Kind of non-magnetic powder | Goethite | Goethite | Goethite |
| Edge weave amount (μm) | 0.8 | 0.8 | 0.9 |
| Surface roughness Ra of | 2.2 | 2.6 | 2.9 |
| magnetic layer (nm) | | | |
| C (dB) | 1.8 | 1.5 | 1.1 |
| C/N (dB) | 2.1 | 1.9 | 1.3 |
| Initial error rate (×10⁻⁷) | 3.5 | 4.3 | 5.8 |
| Error rate after running (×10⁻⁷) | 8.7 | 12 | 7.7 |
| Error rate after storage (×10⁻⁷) | 13 | 13 | 17 |

TABLE 2

| | Comparative Example No. | | |
|---|---|---|---|
| | 1 | 2 | 3 |
| Particle size of | 110 | 100 | 110 |
| non-magnetic powder (nm) | | | |
| Kind of non-magnetic powder | Hematite | Goethite | Goethite |
| Edge weave amount (μm) | 2.3 | 1.1 | 1.0 |
| Surface roughness Ra of | 4.5 | 3.1 | 3.4 |
| magnetic layer (nm) | | | |
| C (dB) | 0.0 | 0.9 | 0.7 |
| C/N (dB) | 0.0 | 1.1 | 0.9 |
| Initial error rate (×10⁻⁷) | 47 | 23 | 31 |
| Error rate after running (×10⁻⁷) | 132 | 57 | 82 |
| Error rate after storage (×10⁻⁷) | 163 | 71 | 93 |

As can be seen from the results in the Tables, the magnetic tapes of Examples 1, 2 and 3 according to the present invention had good C/N, the small error rate and the small increase of the error rate after running and storage. Since the magnetic tapes of Comparative Examples 1, 2 and 3 did not satisfy the requirement of the present invention, at least one of C/N, the initial error rate and the error rate after running or storage was not good. Thus, the magnetic tapes of Comparative Examples cannot be practically used.

1. A magnetic tape comprising a non-magnetic support, a magnetic layer formed on one surface of said non-magnetic support and containing a magnetic powder, a primer layer provided between said non-magnetic support and said magnetic layer and containing a non-magnetic powder, and a back coat layer formed on the other surface of said non-magnetic support, wherein said non-magnetic powder is goethite particles having an average particle size in a range of from 5 nm to 100 nm and said magnetic tape has an edge weave amount of 1.0 μm or less.

2. The magnetic tape according to claim 1, wherein said primer layer has a thickness of 0.2 to 1.5 μm.

3. The magnetic tape according to claim 1, wherein said primer layer further contains carbon black having an average particle size of 0.01 to 0.1 μm and aluminum oxide particles having an average particle size of 0.01 to 0.1 μm.

4. The magnetic tape according to claim 1, wherein said magnetic layer has a thickness of 0.01 to 0.15 μm.

5. The magnetic tape according to claim 1, wherein said magnetic layer has a coercive force of 80 to 320 kA/m.

6. The magnetic tape according to claim 1, wherein said magnetic powder is at least one magnetic powder selected from the group consisting of ferromagnetic iron-based metal magnetic powder and iron nitride magnetic powder.
